(19) United States
(12) Patent Application Publication
(10) Pub. No.: US 2012/0223280 A1
(43) Pub. Date: Sep. 6, 2012

(54) JACK WITH SAFETY DEVICE

(76) Inventor: Haoliang ZHOU, Hangzhou City (CN)

(21) Appl. No.: 13/243,030

(22) Filed: Sep. 23, 2011

(30) Foreign Application Priority Data
Mar. 1, 2011 (CN) 201120058936.1

(51) Int. Cl. B66F 5/04; B66F 17/00

(52) U.S. Cl. 254/8 B

(57) ABSTRACT

This invention relates to a jack with a safety device for automobile maintenance and repair, which includes a base, raising arms installed on the two side panels of the base, a platform installed on the top of the raising arms, and an oil pump to drive the raising arms. The jack may further have two safety devices, each of which includes a rack with reversed gears, a movable safety block to lock the rack, a mechanical linkage system to drive the movable safety block. Each rack may be attached to the bottom of one of the raising arms. The movable safety block may be hinged to the side panel on the same side of the jack as the safety block via an axel hinge. The jack has the characteristics of good safety, simple structure and ease to use.

### BACKGROUND OF THE INVENTION

This invention relates to a jack for automobile maintenance and repair, particularly to a jack with a safety device.

During automobile repair, an automobile jack is generally used to lift a car so that the car may be checked or parts may be replaced. The conventional jack generally includes a base with wheels, hydraulic device (usually an oil pump) driven raising arms and a supporting platform. To use the jack, a pole of the hydraulic device drives the raising arms up so as to lift a car. One issue of using this kind of jack is that the hydraulic device bears most of the pressure of the raising arms when in use; therefore if there are sudden situations such as power failure or oil leakage in the hydraulic device that cause the loss of force in the hydraulic device, the car supported by the raising arms may suddenly drop creating safety hazards.

To solve this issue, some conventional jacks are equipped with two safety pins 12, each of which may be separately inserted into one of the two sides of the raising arms; when the raising arms are at an up position as shown in FIG. 5, the safety pins may be separately moved so that the safety pins sit against the upper sides of the side panels 8 to prevent the raising arms from dropping to ensure safety. However, the insertion of the safety pins has to be done manually. In addition, the safety pins are easily lost because there are no storage places on the jack for the pins when the jack is not in use.

### BRIEF SUMMARY OF THE INVENTION

The purpose of this invention is to solve the aforementioned issues and provide an improved jack that has the characteristics of good safety, simple structure and easy to use.

In at least one embodiment, the jack with a safety device includes a base, raising arms installed on the two side panels of the base, platforms installed on the top of the raising arms, and a hydraulic cylinder to drive the raising arms. The jack may further have the characteristics of two safety devices, each of which includes a rack with reversed gears, a movable safety block to lock the rack, a mechanical linkage system to drive the movable safety block. Each rack may be attached to the bottom of one of the raising arms. The movable safety block may be connected to the side panel on the same side of the jack as the safety block via an axel hinge.

In some embodiments, the mechanical linkage system has a first link, a second link and a third link. An unlocking pedal is hinged to the upper end of the first link. The lower end of the first link is connected to the upper end of the second link; and the combination of the two is hinged on the side panel of the jack. The lower end of the second link is connected to a first end of the third link via a hinge. A second end of the third link is connected to the movable safety block via a hinge. The linkage system may also include a spring. One end of the spring is hooked to the side panel and the other end of the spring is hooked to the middle section of the second link.

In some embodiments, the safety device is installed on each of the side panels between the raising arms and the side panel.

The operational mechanism of the jack is that the movable safety block is constantly engaged with one of the reverse gears of the rack when the raising arms lift a vehicle (as shown in FIG. 2, under the force of the spring, the linkage system pushes the movable safety block toward the rack when the unlock pedal is not depressed by extrinsic force). Because the engagement of the safety block locks the reverse gears, the sudden fall of the raising arms may be prevented even if the oil pump fails. When work on the automobile is done, the unlock pedal may be depressed to force the linkage system to release the movable safety block from engaging with the reversed gears so that the raising arms can be lowered (as shown in FIG. 3).

An advantage of a jack according to this invention is that the raising arms may be locked at a certain height during operation because the jack is equipped with the safety device. Even if the oil pump fails due to power failure or oil leakage, the movable safety block of the safety device may still lock the rack so that the raising arms will not fall and therefore increase the safety of the jack. In addition, the safety device may lock the raising arms at multiple height positions. A jack according to this invention may also solve an issue of the conventional safety pin (which may get lost easily.). Furthermore, the improvement described in this invention is simple and practical, and the manufacturing cost is low.

### BRIEF DESCRIPTION OF THE DRAWINGS

A detailed description of the invention is hereafter described with specific reference being made to the drawings.

FIG. 1 is a side view of an embodiment of a jack according to this invention (un-raised position).

FIG. 2 is a side view of an embodiment of a jack according to this invention in a raised position. (The movable safety block locks the rack.)

FIG. 3 is a side view of an embodiment of a jack according to this invention to show the relative positions and arrangement of different components of the jack. (The safety block does not engage with the rack.)

FIG. 4 is a top view of an embodiment of a jack according to this invention to show the relative positions and arrangement of different components of the jack.

FIG. 5 shows a conventional jack of prior art.

### DETAILED DESCRIPTION OF THE INVENTION

The following is a detailed description of the invention in view of the figures.

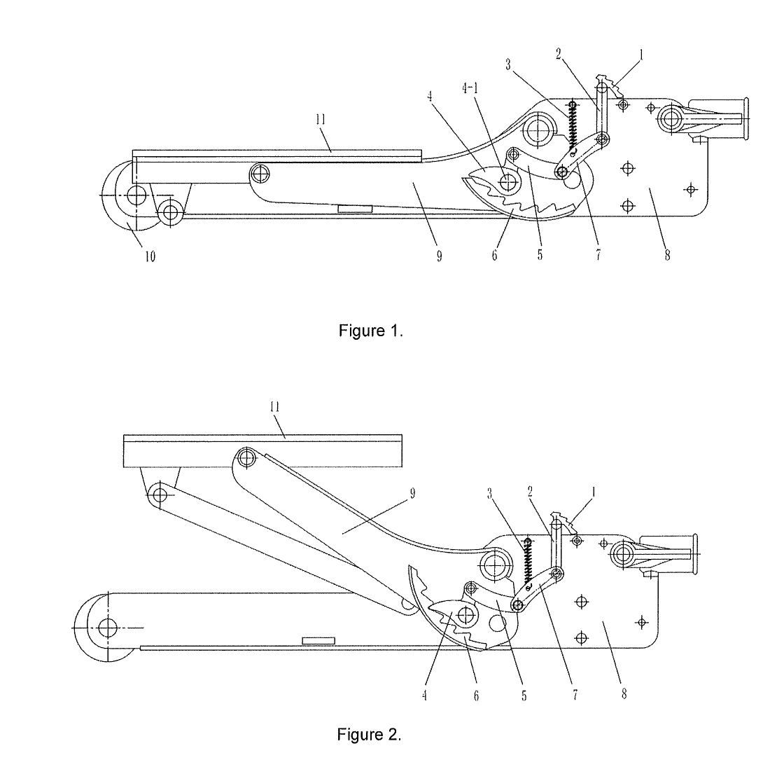

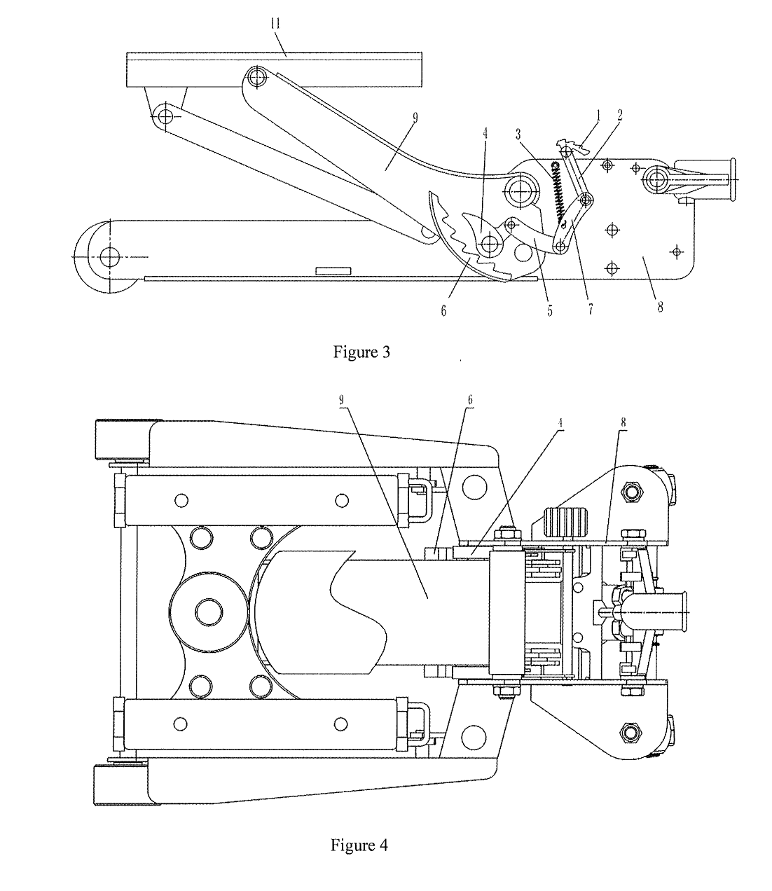

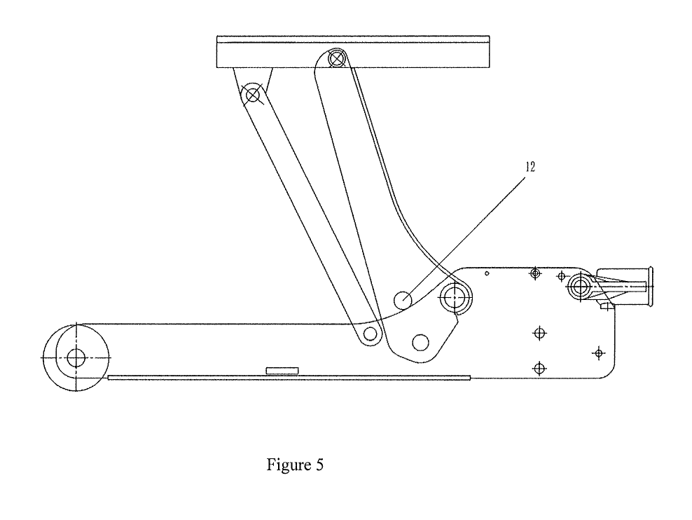

As shown in FIG. 1, an embodiment according to this invention may include a base with wheels 10, raising arms 9 installed on the side panels 8 that are capable of moving up and down, a supporting platform 11 sitting on top of the raising arms 9, and an oil pump driving the raising arms 9 (to simplify the figure, the hydraulic cylinder is omitted from the figure). The arrangement of aforementioned components is similar to that of a conventional jack of prior art.

To increase the safety of the jack, an embodiment according to this invention may include a safety device to lock the raising arms at a certain height position and prevent sudden falls of the raising arms in an emergency situation. The safety device may include a rack with reversed gears 6, a movable safety block 4 to engage and lock the rack 6, and a linkage system to drive the movable safety block. The rack 6 is installed on the bottom of the raising arms. The movable safety block 4 is hinged to the side panel of the same side via an axle hinge 4-1. The linkage system may include a first link 2, a second link 7 and a third link 5. The upper end of the first link 2 has a unlock pedal 1. The lower end of the first link 2 is connected to the upper end of the second link 7, and both ends are jointed together and hinged to the side panel. (In some embodiments, the first link 2 and the second link 7 may be made as a single part. In some embodiments, the first link 2 and the second link 7 may be formed as two separate parts and then assembled together.) The lower end of the second link 7 is connected to a first end of the third link 5. A second end of the third link 5 is coupled to the movable safety block 4. To facility the linkage system to return to its original position, the linkage system may also include a spring 3. One end of the spring 3 is hooked to the side panel and the other end of the spring 3 is hooked to the middle portion of the second link 7.

In some embodiments of the invention, a jack has one set of the safety device installed on each side. The safety device is installed between the raising arms and the side panel (as shown in FIG. 4). In some embodiments, the rack with reversed gears 6 may be molded as an integrated part of the base. Alternatively, the rack may be made separately and then the rack may be bolted to or wielded to the bottom of the base.

1. A jack comprising
a base with a side panel;
a raising arm installed on the side panel, a platform installed on the raising arm;
a hydraulic cylinder to drive the raising arm; and
a safety device, wherein the safety device comprises a rack with reversed gears, a movable safety block engaging with at least one of the reversed gears in a locking position, the movable safety block hinged to the side panel, and a linkage system driving the safety block.

2. The jack of claim 1, wherein the linkage system comprises a first link, a second link and a third link, a pedal hinged to an upper end of the first link, an lower end of the first link connected to an upper end of the second link and hinged to the side panel, an lower end of the second link connected to a first end of the third link, an second end of the third link connected to the movable safety block; and a spring wherein an first end of the spring is hooked to the side panel and a second end of the spring is hooked to a middle section of the second link.

3. The jack of claim 1 further comprising two safety devices, wherein each of the two safety devices is installed between the raising arms and the side panel.

4. The jack of claim 2 further comprising two safety devices, wherein each of the two safety devices is installed between the raising arms and the side panel.
